(19) United States
(12) Patent Application Publication
(10) Pub. No.: US 2017/0221043 A1
(43) Pub. Date: Aug. 3, 2017

(54) TRANSACTION FACILITATION METHODS AND APPARATUSES

(71) Applicant: SSI AMERICA INC., Fort Lauderdale, FL (US)

(72) Inventors: James Buchheim, Aventura, FL (US); Arne Hennig, Davie, FL (US)

(21) Appl. No.: 15/488,802

(22) Filed: Apr. 17, 2017

Related U.S. Application Data
(62) Division of application No. 14/769,955, filed on Aug. 24, 2015, now abandoned.
(60) Provisional application No. 61/814,277, filed on Apr. 21, 2013.
(60) Provisional application No. 61/891,932, filed on Oct. 17, 2013.
(60) Provisional application No. 61/920,794, filed on Dec. 26, 2013.

(51) Int. Cl. G06Q 20/32; G07G 1/00; G07F 7/10; G06Q 20/20; G06Q 20/34; H04W 4/00

(52) U.S. Cl. CPC G06Q 20/3278; G06Q 20/352; H04W 4/008; G06Q 20/341; G07F 7/1008; G06Q 20/20; G07G 1/009

(57) ABSTRACT

Devices and systems using Bluetooth Low Energy (BLE) to facilitate sale transactions are disclosed. The devices can be in the form of a credit card, debit card, smart phone, wearable device such as a watch or glasses. A virtual payment card can store information relevant to a plurality of preexisting accounts and can provide outputs that include wirelessly communicating account information to a wireless device such as the emulation device, programming a dynamically alterable magnetic strip to include magnetized sectors that are magnetized in a fashion that reflects account information, and a visual output of the transaction card whose relevant card information has been communicated wirelessly or to the magnetic strip. Bluetooth-enabled electronic devices are configured to alternately scan and operate as beacons and employ various technologies to detect the signal strengths of other Bluetooth devices, and such signal strength values are wirelessly communicated to a server that resolves the various signal strength values into relative locations of each of the Bluetooth electronic devices. The electronic device that has the closest proximity to the emulation device is instructed to communicate information regarding a preexisting account to the emulation device. A proximity detection apparatus employs an RF transceiver and a pair of antennas at two spaced locations that are located at different distances from each of a plurality of signal sources. The signal source whose signal strengths detected at the two locations are of the greatest difference in magnitude is the relatively closest signal source.

### CROSS-REFERENCE TO RELATED APPLICATIONS

The instant application claims priority from U.S. Provisional Patent Application Ser. No. 61/814,227 filed Apr. 21, 2013; U.S. Provisional Patent Application Ser. No. 61/891,932 filed Oct. 17, 2013; and U.S. Provisional Patent Application Ser. No. 61/920,794 filed Dec. 26, 2013, the disclosures of which are incorporated herein by reference.

### BACKGROUND OF THE INVENTION

The disclosed and claimed concept relates generally to electronic equipment and, more particularly, to electronic equipment that is usable to facilitate financial transactions and other transactions, as well as associated methods.

Credit cards, debit cards, and the like are used during numerous types of transactions. One such type of transaction is a Point Of Sale (POS) transaction that occurs at the location where the sales transaction or other type of transaction has occurred. For example, a purchaser takes goods that are desired to be purchased to a checkout location that typically includes a cash register and a POS credit card terminal that are hard-wired together. The cashier enters the sales transaction into the cash register and calculates a total. If the user desires, the user may pay the needed funds by swiping the magnetic strip of a credit card through the POS terminal and causing the magnetic card reading head to magnetically detect the account information that is stored on the magnetic strip as the strip is translated past the magnetic reading head. Depending upon a number of factors such as the nature of the card (i.e., credit or debit or prepaid funds), the nature of the retailer or seller, and the nature of the transaction, the user may be requested to enter a PIN or, for example, the purchaser's ZIP code. Alternatively or in addition thereto, the cashier may manually type into the cash register certain information that is displayed on the card itself, such as the last four digits of the credit card number.

While such transaction methodologies and devices have been generally effective for their intended purposes, they have not been without limitation. For instance, in order to perform a credit card or other type of card transaction in the fashion set forth above, the purchaser typically must remove a wallet from a pocket or a purse, select a desired credit card, and manually slide the magnetic strip of the card through the card reader in order for the account information to be registered with the POS terminal. This takes time and effort, and the POS terminal does not always read the magnetic strip the first time a card is swiped, necessitating further swipes until the account information is properly detected and entered into the POS terminal.

Moreover, people often carry numerous cards such as credit cards, debit cards, and the other cards that may be related to other types of accounts. Not only is the quantity of cards cumbersome to carry due to their overall weight and volume, the selection process whereby a purchaser must look through a large number of cards, possibly in different locations, takes effort.

It thus would be desirable to provide improvements.

### SUMMARY OF THE INVENTION

In one aspect the invention comprises emulation device comprising a processor apparatus comprising a processor and a storage; an input apparatus structured to provide input signals to the processor apparatus; an output apparatus structured to receive output signals from the processor apparatus and to provide an output based at least in part upon the output signals; the input apparatus comprising a radio frequency (RF) receiver; the output apparatus comprising a magnetic field generator; the storage having stored therein a number of routines which, when executed on the processor, cause the emulation device to perform operations comprising: receiving from another device an RF signal comprising data that is representative of a preexisting account; converting at least a portion of the data into a series of analog signals that are representative of the at least portion of the data; and inputting the series of analog signals into the magnetic field generator to cause the magnetic field generator to generate a time-varying magnetic field that is detectable by a magnetic card reader and that is representative of the account.

In another aspect the invention comprises a virtual payment card comprising: a support; a processor apparatus disposed on the support and comprising a processor and a storage; an input apparatus disposed on the support and structured to provide input signals to the processor apparatus; an output apparatus disposed on the support and structured to receive output signals from the processor apparatus and to provide an output based at least in part upon the output signals; the input apparatus comprising a radio frequency (RF) receiver; the output apparatus comprising at least one of a dynamically alterable magnetic strip, an RF transmitter, and a visual display; the storage having stored therein a number of routines which, when executed on the processor, cause the emulation device to perform operations comprising: receiving from another device an RF signal comprising data that is representative of a preexisting account; storing at least a portion of the data in the storage; and responsive to a predetermined input, outputting at least one of: an instruction to alter the electromagnetic properties of the magnetic strip to be representative of the account, an RF signal comprising data that is representative of the account, and a visual depiction of a card that is associated with the account.

In another aspect the invention comprises an method of facilitating a transaction, comprising: receiving from a first radio frequency (RF) transceiver a signal that is representative of a proximity thereto of a second RF transceiver and a third RF transceiver, one of the first, second, and third RF transceivers being situated at a transaction terminal; receiving from the second RF transceiver another signal that is representative of a proximity thereto of the first RF transceiver and the third RF transceiver; identifying, based at least in part on the signal and the another signal, a particular RF transceiver from among the other of the first, second, and third RF transceivers as being situated relatively closer to the transaction terminal; receiving data that is representative of a preexisting account which is associated with the particular RF transceiver; and employing at least a portion of the data to complete a transaction on the transaction terminal.

Another aspect of the invention comprises a method of facilitating a transaction, comprising: receiving a first signal from a first radio frequency (RF) transceiver at a first time at which the first RF receiver is within a predetermined proximity of a transaction terminal; associating with the first RF transceiver a first time stamp representative of the first time; receiving a second signal from a second RF transceiver at a second time subsequent to the first time at which the second RF receiver is within a predetermined proximity of a transaction terminal; associating with the second RF transceiver a second time stamp representative of the second time; retrieving a first data set that is representative of a first preexisting account which is associated with the first RF transceiver; employing at least a portion of the first data set to complete a first transaction on the transaction terminal; retrieving a second data set that is representative of a second preexisting account which is associated with the second RF transceiver; and subsequent to the completion of the first transaction, employing at least a portion of the second data set to complete a second transaction on the transaction terminal.

In another aspect, the invention comprises a method of facilitating a transaction, comprising: detecting at a pair of locations that are in the vicinity of a transaction terminal and that are at different distances from a radio frequency (RF) transceiver a pair of signal strength values of a signal from the RF transceiver; detecting at the pair of locations another pair of signal strength values of another signal from another RF transceiver; determining that a strength difference between the pair of signal strength values is greater than another strength difference between the another pair of signal strength values; responsive to the determining, concluding that the RF transceiver is relatively closer to the transaction terminal than the another RF transceiver; retrieving data that is representative of a preexisting account which is associated with the RF transceiver; and employing at least a portion of the data to complete a transaction on the transaction terminal.

The system of the invention allows determination of proximity or distance between a customer carrying or holding a device according to the invention in the form of a BLE-enabled credit card or specially programmed BLE-enabled smart phone or wearable device such as a watch or glasses or a tablet computer and a point of sale terminal (POS) which can be in the format of a traditional cash register or a tablet or any other computation device which is programmed to process sale transactions. The proximity calculation can be based on BLE signal strength, which is an especially preferred aspect of the invention.

In another aspect, the system allows people in line at a store, airport, hotel check-in counter, and the like to detect and measure each other and determine their sequence in a line using beacon information at the cashier, ticket agent, hotel clerk, and the like, which optionally includes communication with a remote server which stores and processes data to enable this function.

In cases where the people in line do not have internet access, other methods such as BLE can be used. By people in line, we are referring to BLE enabled smart phones, wearable devices, tablets, or the like which have capability to transmit a unique identifier.

The devices of the invention in some embodiments are wearable, for example a BLE-enabled watch, “Google glasses,” or the like.

In some embodiments the power source is a battery, a coil, or a source of renewable energy, wherein the device is always on and periodically transmits the encrypted payload at least once every three seconds.

In some embodiments the device is in the format of a credit card, debit card, or loyalty card.

In some embodiments a point of sale terminal is located within 20 meters of the device, within 10 meters of the device, or within 3 meters of the device, the device being, for example a BLE-enabled credit card, wearable device, or smart phone.

In some embodiments the point of sale terminal includes means to send the unique identifier to a remote server which is programmed to authenticate the device and return credit or debit card data which corresponds to the unique identifier in a format such that the point of sale terminal can process a sale and charge the credit card or debit card corresponding to the device.

In some embodiments the device includes a display for displaying an image of a credit card.

In some embodiments the device includes a magnetic field strip and a coil and is adapted to receive data via the coil.

In some embodiments the device is programmed to transmit credit or debit card numbers via the UHF radio waves.

In some embodiments the device is in a beacon format with a coil and is located adjacent to a point of sale terminal, optionally next to a magnetic card reader slot.

In some embodiments a beacon comprises a coil which is adapted to emulate a credit card swipe which transmits credit card data.

In some embodiments the beacon is adapted to communicate with a customer's smart phone and the point of sale terminal, the beacon adapted to calculate based on relative signal strength of a customer's smart phone an approximate distance of the smart phone to the beacon and thereby calculate whether the customer is first in line.

In some embodiments the device is programmed to facilitate communication between the beacon and a customer smartphone and/or BLE enabled credit card, wherein the customer smartphone is enabled to send customer credit card data via BLE to the beacon which, in turn, automatically translates and convert the said credit card data into a magnetic field.

In some embodiments the system is adapted to calculate which of a plurality of smart phones is closest to the beacon based on signal strength.

In some embodiments adapted to create a magnetic field that would resemble a credit card being swiped and send in a magnetic field the credit card number to a magnetic card reader in or on the point of sale terminal.

In certain embodiments the system is adapted to authenticate a smart phone user by requiring entry of a PIN number, zip code, phone number, or identification code on the actual POS. A biometric scanner can be used in some embodiments to authenticate a user.

A BLE-enabled standalone display on or associated with the point of sale terminal can display a question to ask a customer which must be answered correctly for authentication. The system can be adapted to include voice recognition so that the customer may speak the answer rather than keying it into a device.

In some cases to the system can determine which of device among a plurality of devices is closest to the point of sale terminal or which among the plurality of devices was first in line using comparative signal strength routines.

### BRIEF DESCRIPTION OF THE DRAWINGS

An understanding of the disclosed and claimed concept can be gained from the following Description when read in conjunction with the accompanying drawings in which:

FIG. 1 is a schematic depiction of an improved emulation device in accordance with the disclosed and claimed concept;

FIG. 2 is a schematic depiction of a POS terminal in connection with which the emulation device of FIG. 1 is advantageously usable;

FIG. 3 is another depiction of the POS terminal having the emulation device of FIG. 1 situated thereon;

FIG. 4 is a schematic depiction of an improved visual display apparatus in accordance with the disclosed and claimed concept that is usable in conjunction with a transaction system;

FIG. 5 is a front view of the visual display apparatus of FIG. 4 having an exemplary visual output on its display;

FIG. 6 is a schematic depiction of an improved virtual payment card in accordance with the disclosed and claimed concept;

FIG. 7 is an exemplary depiction of the front of the virtual payment card of FIG. 6;

FIG. 8 is an exemplary depiction of the rear of the virtual payment card of FIG. 6;

FIG. 9 is a depiction of the recording of electronic information stored magnetically on a credit card;

FIG. 10 is a depiction of the photographing of a front surface of the credit card;

FIG. 11 is a schematic top plan view of a plurality of electronic devices distributed along a checkout aisle pursuant to the performance of a transaction; and

FIG. 12 is a schematic depiction of an improved proximity detection apparatus in accordance with the disclosed and claimed concept.

Similar numerals refer to similar parts throughout the specification.

### DETAILED DESCRIPTION OF THE INVENTION AND PREFERRED EMBODIMENTS

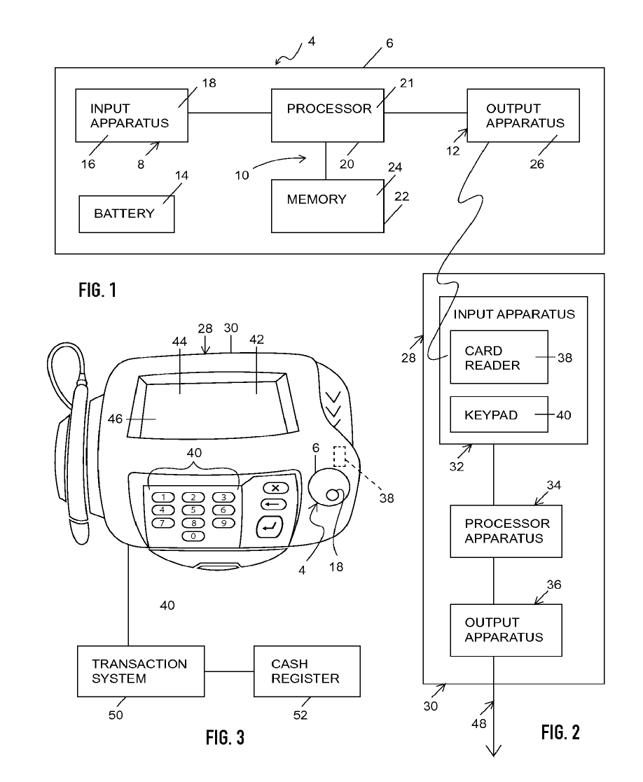

An improved emulation device 4 in accordance with the disclosed and claimed concept is depicted in a schematic fashion in FIG. 1 and is also depicted in FIG. 3. As will be set forth in greater detail below, the emulation device 4 is usable in conjunction with a legacy Point Of Sale (POS) terminal that is connected with a transaction system 50. As will also be set forth in greater detail below, the emulation device 4 advantageously enables the POS terminal 28 to have a wireless communication capability without modifying the POS terminal 28.

The emulation device 4 can be said to include a support 6 upon which are disposed an input apparatus 8, a processor apparatus 10, and an output apparatus 12. The emulation device 4 further includes a tiny battery 14 or other power source that is situated on the power support 6.

The exemplary input apparatus 8 includes a Radio Frequency (RF) receiver 16 which, in the depicted exemplary embodiment, is a receiver component of an RF transceiver that is situated on the support 6. Such an RF transceiver may include the RF receiver 16 and an RF transmitter as separate components, although the RF transceiver could alternatively be configured to share certain elements between its RF receiver component and it RF transmitter component. The RF receiver 16 enables wireless transmissions to be wirelessly received on the emulation device 4.

The input apparatus 8 further includes a button 18 that is depicted in an exemplary fashion in FIG. 3. The button 18 is actionable to initiate certain functions, such as the approval of some types of a financial transaction or other transaction, by way of example. Use of the button 18 during the course of a transaction is optional, however, and typically will depend upon factors such as the type of transaction that is being performed and other such factors.

The exemplary processor apparatus 10 can be said to include a processor 20 that is connected with a memory 22. The processor 20 can be any of a wide variety of microprocessors or other processors and, in the depicted exemplary embodiment, includes a Bluetooth chip 21. In the depicted exemplary embodiment, the Bluetooth chip 21 is operable to cause the RF transceiver to provide wireless communications according to the Bluetooth Low Energy (BLE) protocol IEEE 802.15.4, although other RF communications protocols may be employed without departing from the present concept.

The memory 22 is a storage which can be any of a wide variety of volatile and/or non-volatile storage media and may include RAM, ROM, FLASH, etc. without limitation. In the depicted exemplary embodiment, the memory 22 has a number of routines 24 stored therein which, when executed on the processor 20, cause the emulation device 4 to perform certain functions as will be set forth in greater detail below.

The output apparatus 12 includes a magnetic field generator 26 which is generally in the nature of a magnetic coil that receives output signals from the processor 20 which causes the magnetic field generator 26 to generate a time-varying magnetic field that is detectable by the POS terminal 28.

The exemplary POS terminal 28 is a legacy device, meaning that it is already installed and operational with the transaction system 50. As will be set forth in greater detail below, the improved emulation device 4 can be easily added to the POS terminal 28 to enhance its functionality without requiring any modification of the POS terminal 28.

The POS terminal 28 can be said to include a support 30 upon which are situated an input apparatus 32, a processor apparatus 34, and an output apparatus 36 as are depicted in a schematic fashion in FIG. 2. As can be seen in FIG. 3, the emulation device 4 is received on the support 30. The emulation device 4 may be retained on the support 30 through the use of an adhesive pad that extends between the support 6 and the support 30, although other physical attachment methodologies may be employed without departing from the present concept.

The input apparatus 32 includes a magnetic card reader 38 and a keypad 40 that provide input signals to the processor apparatus 34. The POS terminal 28 additionally includes a touch sensitive display 42 that includes an input component 44 that is a part of the input apparatus 32. The touch sensitive display 42 also includes an output component 46 that is a part of the output apparatus 36. The output apparatus 36 further includes a hard-wired connection 48 that is connected with the transaction system 50.

As can be seen in FIG. 3, the transaction system 50 is additionally connected with a cash register 52 of the type having a keypad, processor apparatus, and the like. While the POS terminal 28 and the cash register 52 are depicted as both being connected directly with the transaction system 50, it is understood that other arrangements and interconnections are possible without departing from the present concept.

As set forth above, FIG. 3 depicts the emulation device 4 affixed to an external surface of the support 30 and is situated generally in the vicinity of the magnetic card reader 38. As is generally understood in the relevant art, a magnetic strip of a credit card or other type of transaction card has various sectors that are differently magnetized and which are magnetically detected by a card reader such as the magnetic card reader 38. That is, as the card is swiped and the magnetic strip is moved past the card reader, the variously magnetized sectors of the magnetic strip are sequentially magnetically detected by the card reader, and the output from the card reader is interpreted as account data. In accordance with the disclosed and claimed concept, the processor apparatus 34 provides output signals to the output apparatus 36 to cause the magnetic card reader 38 to generate a time-varying magnetic field that is detectable by the magnetic card reader 38 in the same fashion that the magnetic card reader 38 would sequentially detect the variously magnetized sectors of a magnetic strip of a transaction card. That is, the time-varying magnetic field generated by the magnetic field generator 26 is detectable by the magnetic card reader 38 and causes the magnetic card reader 38 to behave in the same fashion as when a magnetic strip is translated past the magnetic card reader 38. The emulation device 4 is thus operable to emulate a swipe of a transaction card having a magnetic strip past the magnetic card reader 38.

More particularly, the emulation device 4 can facilitate a transaction such as a financial transaction by wirelessly receiving from another device information regarding a preexisting account and then cause the magnetic field generator 28 to output a time-varying magnetic field that is representative of the information and thus is representative of the preexisting account. In the depicted exemplary embodiment, the emulation device 4 wirelessly communicates with RF transceivers of other electronic devices via BLE, and thus the wireless communication between the emulation device 4 and the other device will typically include a pairing between the other device and the emulation device 4. After such pairing, the processor apparatus 10 can receive via the RF receiver 16 the information or other data that is representative of the preexisting account which the purchaser, i.e., the user of the other device, wishes to employ in conducting the transaction. Once such information or data regarding the preexisting account has been received on the emulation device 4, the processor apparatus 10 employs one or more of the routines 24 to convert the data into a series of analog signals that are representative of the preexisting account and which are output from the processor apparatus 10 and are input to the magnetic field generator 26. The series of analog signals cause the magnetic field generator 26 to generate a time-varying magnetic field that is representative of the preexisting account (or at least is representative of the data that is representative of the account). The time-varying magnetic field is detectable by the magnetic card reader 38 of the POS terminal 28, which causes the information regarding the preexisting account to be input to the transaction system 50 and used in completing a transaction. In so doing, the purchaser may be required to actuate the button 18 in order to authorize the transaction, although this is entirely optional.

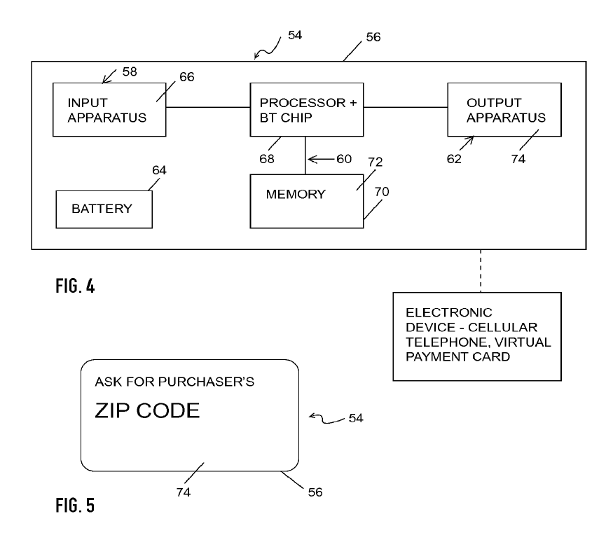

Further optionally, the cashier may be instructed to enter some type of validation code into the cash register 52 in order to provide final authorization to complete the transaction. In so doing, the cashier may potentially employ an improved virtual display apparatus 54 that is in accordance with the disclosed and claimed concept and that is depicted in FIGS. 4 and 5. The exemplary visual display apparatus 54 is depicted in FIG. 4 in a schematic fashion as including a support 56 and as further including an input apparatus 58, a processor apparatus 60, and an output apparatus 62 that are situated on the support 56. The visual display apparatus 54 further includes a tiny battery 64 that is situated on the support 56 and that provides electrical power to the various components of the visual display apparatus 54, although other power sources potentially can be used without departing from the present concept. As will be set forth in greater detail below, the visual display apparatus 54 can output to the cashier visual information such as a question that the cashier is instructed to ask of the purchaser and the reply to which will be entered by the cashier into the cash register 52.

The input apparatus 58 includes an RF receiver 66 which, in the depicted exemplary embodiment, is the receiver component of an RF transceiver. The processor apparatus 60 includes a processor 68 that includes a microprocessor and a Bluetooth chip that causes the RF transceiver to communicate wirelessly according to the BLE protocol. The visual display apparatus 54 can be paired with, for example, the cellular telephone or other wireless electronic device of the user, and an application on the cellular telephone can provide to the visual display apparatus 54 information regarding the material that is to be output.

The processor apparatus 60 further includes a memory 70 that acts as a storage and that may include RAM, ROM, FLASH, and the like without limitation. In the depicted exemplary embodiment, the processor apparatus 60 further includes a number of routines 72 that are stored in the memory 70 and that are executable on the processor 68. As employed herein, the expression “a number of” and variations thereof shall refer broadly to any non-zero quantity, including a quantity of one.

The output apparatus 62 includes a display 74 that is situated on the support 56 and that is operable to provide a visual output on the support 56. The exemplary display 74 employs e-paper and/or e-ink technologies or other appropriate technologies. Such technologies advantageously cause the display 74 to consume power only when its visual depiction changes and to consume not power during periods in which the visual depiction or visual display is static. This advantageously enables the battery 64 to last for an extended period of time.

The visual display apparatus 54 is depicted in FIG. 5 as outputting the instruction: “ASK FOR PURCHASER'S ZIP CODE.” The instruction that is output on the display 74 is intended to be viewed only by the cashier and is intended to be out of the view of the purchaser. The display 74 may therefore employ some type of feature such as collimation or to be otherwise direction specific in order to avoid viewing by the purchaser.

As an example, the purchaser's cellular telephone or other wireless device may wirelessly communicate instructions to the RF receiver 66 which provides input to the processor 68 to cause the processor 68 to provide output signals that cause the display 74 to output the instruction that is depicted generally in FIG. 5. The cellular telephone or other wireless device may subsequently also output for viewing by the cashier the correct answer. Upon receiving from the purchaser the answer to the question posed by the cashier, the cashier can then enter a final authorization for the transaction. Alternatively, the cashier may input the response that was received from the purchaser into the cash register 52 in order to finalize the transaction. It is understood, however, that the display 74 can be instructed to output other information that pertains to the account or other questions requesting information that pertains to the account. For example, the display 74 can be caused to output a visual display such as “HELLO, MR. JOHNSON” if the account owner is male and has a last name of “JOHNSON”. Virtually any type of information that pertains to the use of the account, such as a request for verification information regarding the account or a request to provide details of the account can be driven by wireless output from the purchaser's cellular telephone or other electronic device.

Since the visual display apparatus 54 is self-contained, meaning that it is self-powered via the battery 64 and includes its own RF communication system and display 74, the visual display apparatus 54 can be provided and installed as a unit either on the cash register 52 or in a location that will enable the visual output on the display 74 to be viewed by the cashier but to be unviewable by the customer. The support 56 can be provided with an adhesive pad that will enable the visual display apparatus 54 to be mounted most anywhere without requiring hard-wired connections with any other devices, which is advantageous.

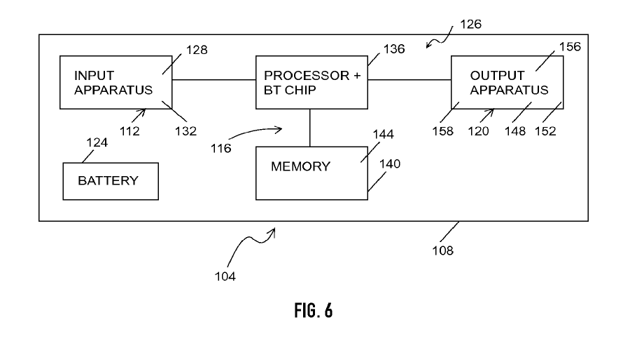

An improved virtual payment card 104 in accordance with the disclosed and claimed concept is depicted in generally in FIGS. 6-10. The virtual payment card 104 is an example of a wireless device (as mentioned above as being in the possession of the purchaser) that provides to the visual display apparatus 54 or to the emulation device 4 information or other data regarding a preexisting account that is desired to be used in completing a transaction. As will be set forth in greater detail below, the virtual payment card 104 advantageously can store information regarding a plurality of preexisting accounts of various types and is of the size and thickness of a conventional credit card or other transaction card.

The exemplary virtual payment card 104 can be said to include a support 108 and to further include an input apparatus 112, a processor apparatus 116, an output apparatus 120, and a tiny battery 124 situated on the support 108. As suggested above, the support 108 is of a thin and generally planar configuration that is of the thickness and size of a conventional credit card or other transaction card. The virtual payment card 104 further includes an RF transceiver 126 that includes an RF receiver component 128 that is a part of the input apparatus 112 and an RF transmitter component 158 that is a part of the output apparatus 120. The input apparatus 112 further includes a button 132 that is actuatable to provide input to the processor apparatus 116 and that may be in the form of a mechanical button, a virtual button such as a predefined area on a touch sensitive display, and the like without limitation.

The processor apparatus 116 can be said to include a processor 136 that includes any type of processor, such as a microprocessor, and includes a Bluetooth chip to cause the RF transceiver 126 to operate according to the BLE protocol. The processor apparatus 116 further includes a storage in the form of a memory 140 that can be any of a wide variety of storage devices such as RAM, ROM, FLASH, and the like without limitation. The processor apparatus 116 further includes a number of routines 144 that are stored in the memory 140 and that are executable on the processor 136 to cause the virtual payment card 104 to perform various operations.

The output apparatus 120 further includes a front display 148 on a frontal surface of the support 108 and a rear display 152 on the opposite surface of the support 108. The front and rear displays 148 and 152 are visual displays that provide visual output and that employ, for instance, e-paper and/or e-ink technology or employ other appropriate technology.

The output apparatus further includes a dynamically alterable magnetic strip 156 adjacent the rear display 152 that is connected with the processor 136. The dynamically alterable magnetic strip 156 has a plurality of sectors that can be altered responsive to output signals from the processor 136 to change the magnetic properties of the various sectors as needed. In particular, the magnetic strip 156 is configurable to replicate the magnetic strip of a conventional credit card or other transaction card, and it is dynamically alterable to change its magnetic properties to replicate the magnetic strip of another transaction card as needed. Once the magnetic strip 156 has been altered to represent the magnetic strip of a preexisting account, the virtual payment card 104 can be swiped through a card reader, such as the magnetic card reader 38 of the POS terminal 28, with the dynamically alterable magnetic strip 156 being magnetically detected and read by the card reader in a conventional fashion. Of course, such information can alternatively be wirelessly communicated to the emulation device 4 by the RF transceiver 126.

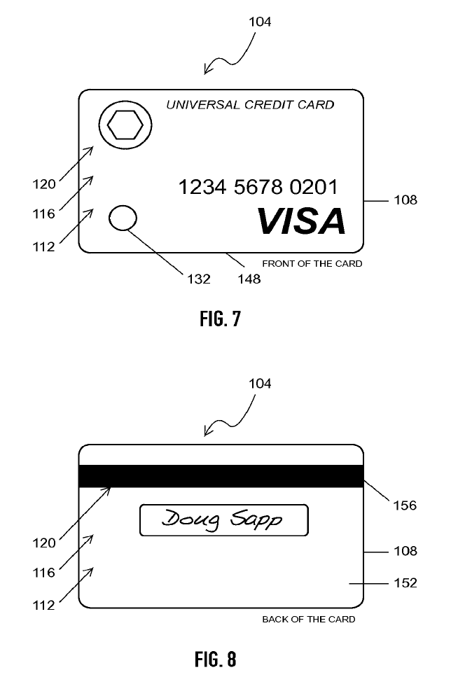

As suggested above, the virtual payment card 104 can store in its memory 140 information pertaining to plurality of credit cards or other transaction cards for later use. In so doing, a user can simply carry the virtual payment card 104 without needing to carry the other numerous transaction cards that the user might otherwise be required to carry. The routines 144 enable the memory 140 to store not only the account information such as the account number and other information that typically may be stored in the magnetic strip of a transaction card, but can also store images of the front and rear surfaces of such a transaction card and can display the images thereof on the front and rear displays 148 and 152, respectively in conjunction with configuring the dynamically alterable magnetic strip 156 to replicate the magnetic strip of the same transaction card. This is depicted generally in FIGS. 7 and 8.

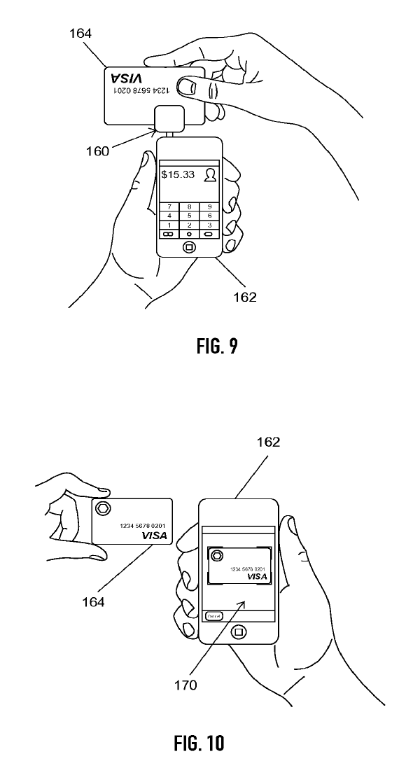

The information regarding the various credit cards and other transaction cards that may be possessed by an individual can be transferred to the virtual payment card 104 for storage thereon in a fashion depicted generally in FIGS. 9 and 10. For example, a credit card 164 can be swiped through a magnetic strip reader module 160 such that the magnetic strip of the credit card 164 is magnetically detected and read by the magnetic strip reader module and is input to an electronic device such as a cellular telephone 162 or other appropriate device to which the magnetic strip reader module 160 is connected. In so doing, a routine 144 may be caused to be executed on the processor 136 in order to cause the magnetic content of the magnetic strip of the credit card 164 to be converted into an account number or other information regarding the preexisting account that is represented by the credit card 164.

The front and rear surfaces of the credit card 164 can then be photographed by a camera of the cellular telephone 162 by employing a routine 144 that is executed on the processor 136. After being photographed, the images of the front and rear of the credit card 164 can then be output on a display 170 of the cellular telephone 162 for visual confirmation by the user.

Once the front and rear images of the transaction card and the account number or other information relevant thereto has been stored in the cellular telephone 162, a wireless Bluetooth transceiver of the cellular telephone 162 can then be paired with the RF transceiver 126 of the virtual payment card 104, whereupon the images and other information pertinent to the preexisting account (the credit card 164 in the depicted exemplary embodiment) can then be wirelessly communicated to the virtual payment card 104 and stored in the memory 140 thereof. Depending upon the particular application, it may be desirable for the images and account information to be stored in volatile memory so that if the virtual payment card 104 is lost and is disassembled by another person, the loss of battery power will cause the stored account information to be lost prior to misappropriation by the other person.

Once the information regarding the user's various transaction cards has been stored in the virtual payment card 104, the user can select a default account that will be employed in a default fashion for any transactions for which the virtual payment card 104 is employed. FIGS. 7 and 8 depict the default credit card images being depicted on the front and rear displays 148 and 152, and it is reiterated that the dynamically alterable magnetic strip 156 is likewise configured to reflect the account information or other appropriate information pertaining to the default account.

The virtual payment card 104 can then be swiped, such as on the POS terminal 28, whereupon the dynamically alterable magnetic strip 156 can be magnetically detected and read by the magnetic card reader 38 and the account information detected thereby can be input to the processor apparatus 34. Alternatively, if it is desired that the account information be communicated wirelessly, such as to the emulation device 4, the account information pertaining to the default account can be communicated wirelessly via the RF transceiver 126 being paired with the RF transceiver 16 using the BLE protocol. While in the depicted exemplary embodiment, the information and images pertinent to the various transaction cards are stored in the memory 140, it is understood that in other embodiments the pertinent information and data can be stored in the virtual cloud or elsewhere, if needed, in order to avoid having the stored data falling into the hands of another person if the virtual payment card 104 happens to become lost.

The default preexisting account can be changed by the user by actuating the button 132 or taking other appropriate action, whereupon the various accounts can either be simultaneously displayed as icons on the front display 148, or the user potentially could scroll through the various accounts with repeated actuations of the button 132. Furthermore, even if the default preexisting account is not changed, the user can select, by actuating the button 132 a number of times, another preexisting account for use of any given transaction. The ability of the virtual payment card 104 to provide wirelessly or through the dynamically alterable magnetic strip 156 account information pertinent to a preexisting account, the initiation and completion of transactions is facilitated, thereby saving time and effort.

As suggested above, various electronic devices such as the virtual payment card 104, the cellular telephone 162, and other electronic devices can be employed to wirelessly communicate account information to the emulation device 4 for input into the transaction system 50 via the POS terminal 28. The virtual payment card 104 and a cellular telephone such as the cellular telephone 162 are merely but two examples of Bluetooth enabled wireless devices that can pair with the emulation device 4 and that can provide thereto information regarding a preexisting account that is intended to be used to conduct a transaction. It is understood, however, that the Bluetooth protocol enables the RF transceivers of electronic devices to be simultaneously wirelessly paired with a plurality of other Bluetooth enabled RF transceivers. As such, it would be desirable in the presence of a plurality of people wishing to conduct transactions with the POS terminal 28 to ensure that the account information of any given individual is employed to conduct the transaction desired by that same individual rather than to erroneously employ an account owned by another individual to process the transaction. Accordingly, a proximity detection system 210 is provided which, in various embodiments, is usable to detect which individual from among a plurality of individuals is situated in closest proximity to the POS terminal 28 and to employ the account information from that individual to complete a transaction that is being conducted by that individual with the POS terminal 28.

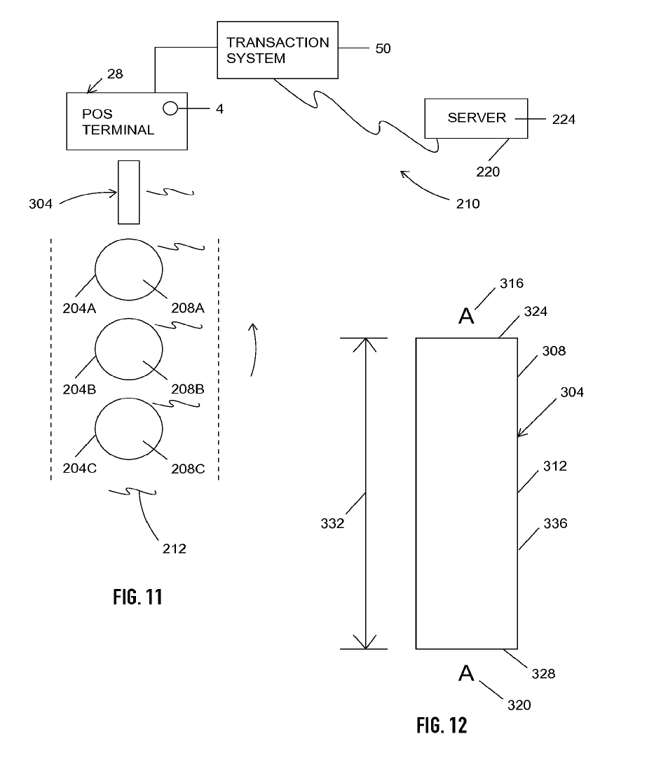

More particularly, the POS terminal 28 is depicted in FIG. 11 as being at the end of a schematically depicted checkout aisle 212. More particularly, a plurality of electronic devices 204A, 204B, and 204C, which may be individually or collectively referred to herein with the numeral 204, are carried by individuals who are standing in line at different distances from the POS terminal 28. The electronic devices 204A, 204B, and 204C each include an RF transceiver 208A, 208B, and 208C, which may be individually or collectively referred to herein with the numeral 208, which is controlled by a Bluetooth chip that operates the RF transceivers 208 according the BLE protocol. While the electronic devices 204 are depicted in FIG. 11 as being themselves situated along the checkout aisle 212 at different distances from the POS terminal 28, it is reiterated that the electronic devices 204 are in some fashion carried by individuals (that are not expressly depicted herein) who desire to employ the electronic devices 204 to complete individual transactions on the POS terminal 28.

The proximity detection system 210 can be said to include a server 220 having a processor apparatus that stores and executes various routines 224 which can resolve signals from the RF transceivers 208 and the RF transceiver 16 of the emulation device 4 situated on the POS terminal 28 into proximity values for each of the electronic devices 204 that are representative of the relative distance of each electronic device 204 from the POS terminal 28.

More particularly, and as is understood in the relevant art, the electronic devices 204 can each have a routine executed thereon that places the RF transceivers 208 into a mode whereby the RF transceivers 208 each alternately scan and operate as beacons, and the RF transceiver 16 of the emulation device 4 situated on the POS terminal 28 can be operated in a likewise fashion. The RF transceivers 16, 208A, 208B, and 208C can thus each pair with one another and can detect via Received Signal Strength Indication (RSSI) principles the various signal strengths of each of the other RF transceivers. For example, the RF transceiver 16 can scan and detect each of the RF transceivers 208A, 208B, and 208C, and can employ RSSI to determine a signal strength value (in dB) for the signals from each of the RF transceivers 208A, 208B, and 208C. Likewise, the RF transceiver 208B can pair with and detect using RSSI the signal strengths for each of the RF transceivers 16, 208A, and 208C.

All of the various signal strength values detected by all of the RF transceivers 16, 208A, 208B, and 208C are then communicated via BLE protocol or other protocol to the server 220 where the routines 224 resolve the various signal strength values into the relative proximity of each of the electronic devices 204A, 204B, and 204C to the POS terminal 28. When an individual is attempting to conduct a transaction at the POS terminal 28, the proximity detection system 210 performs the aforementioned analyses and identifies which electronic device 204 has the closest proximity to the POS terminal 28. The server 220 then wirelessly sends to the RF transceiver 208 that is associated with such closest-proximity device 204 a notification that its account data should be wirelessly communicated to the emulation device 4. Thereupon, the RF transceiver 208 that received such indication from the server 220 wirelessly communicates to the RF transceiver 16 of the emulation device 4 the information pertinent to the account that the individual wishes to use to complete the transaction. The electronic device 204 that received such indication and that transmitted such account information to the emulation device 4 need not awaken or otherwise indicate to the user that any action occurred on the electronic device 204 itself, which aids in avoiding distraction of the user and facilitates completion of the transaction with minimal effort and time, which is desirable.

It is understood, however, that the various individuals that are distributed along the checkout aisle 212 may be carrying their electronic devices 204 in different fashions. For example, one person may be carrying the electronic device 204A in a purse, and another person may be carrying the electronic device 204B in a pocket, and still another individual may be carrying the electronic device 204C in a hand. Since the human body is composed largely of water, and since water tends to absorb electromagnetic energy at 2.4 gigahertz (GHz), which is the nominal operating frequency for the Bluetooth protocol, the specific way in which an electronic device 204 is carried by a user can have a significant effect on the strength of the signal that is received therefrom on another device due to the variability of the amount of the transmitted signal that can be absorbed by water in the human body or in other individuals. A number of solutions have been developed to overcome this difficulty.

One such methodology is employed if the location of the closest RF transceiver 208 is, at least initially, indeterminate or otherwise uncertain. In such a situation, the server 220 will send an inquiry of some type to those electronic devices 204 whose position is indeterminate, such as a communication requesting to know if the user wishes to conduct a transaction of some type. Upon each such electronic device 204 wirelessly receiving the aforementioned communication, it is anticipated that each such user will withdraw the electronic device 204 from the pocket or the purse, by way of example, and will hold it in the hand. The various signal strengths of the various RF transceivers 16 and 208 can then be again detected on the various electronic devices and resolved into updated relative proximities by the server 220, whereupon each such user whose relative position had been indeterminate can be determined anew. Since all of the electronic devices 204 in such a situation are expected to be held in the same way, i.e., in the user's hand, the effects of the variability of the extent to which water can absorb the 2.4 GHz Bluetooth signal can be ameliorated or normalized.

Another difficulty has been encountered if individuals come into proximity with the POS terminal 208 at different times prior to completion of the transaction. In such a circumstance, the server 220 will apply a time stamp that is associated with the unique ID of each such electronic device 204. The server 220 then employs the time stamps and the unique IDs associated therewith to determine which RF transceiver 208 should receive the notification from the server 220 that the account information is needed. For example, if a first user came close enough to the POS terminal 28 to be paired with the emulation device 4, the unique ID of the paired device is then stored in association with a time stamp. If, at subsequent time, another user brings another electronic device 204 into proximity with the POS terminal 28, and such electronic device 204 becomes paired with the emulation device 4, the unique ID of that electronic device 204 would likewise be stored in association with a time stamp that is subsequent to the aforementioned time stamp. The time stamps are then arranged in chronological order, and the electronic devices 204 associated with the corresponding unique IDs are sequentially informed of the need for account information as each successive transaction is initiated. Such transactions are then completed using the received account information.

The indication from the server 220 to the particular electronic device 204 that has been determined to be situated closest to the POS terminal 208 may alternatively or additionally include an inquiry that is output on a display of the electronic device 204 that requires the user to confirm that the pending transaction at the particular value is to be authorized. Upon the user entering an input on the electronic device 204 that approves or authorizes such a transaction, the electronic device 204 may then communicate to the emulation device 4 the relevant account information. As before, it is noted that the account information need not be stored on the electronic device 204 and rather may be stored in the virtual cloud for retrieval by the electronic device 204 in order to avoid unintended access to the account information by others should the electronic device 204 become lost.

An improved proximity detection apparatus 304 that is depicted in FIGS. 11 and 12 can be used in conjunction with detecting the relative proximity of the electronic devices 204 to the POS terminal 28 and the emulation device 4. The proximity detection apparatus 304 can be employed individually to determine the proximities of the electronic devices 204 or in combination with the above methodologies to determine the proximities.

By way of background, it is understood that the detected strength of a signal from a signal source increases exponentially as the distance between the signal source and the location of detection decreases. For example, the detected signal from a distance of one foot may be on the order of −50 dB whereas the detected signal strength at a distance of three feet may be −70 dB. However, at ten feet away, the signal may be −75 dB and at twenty feet away the signal may be −78 dB.

As such, it has been recognized that by detecting a signal strength at two different distances from each of a plurality of signal sources, the signal source having the greatest detected signal strength difference or delta at the two different locations is the signal that is relatively closest to the two different locations. That is, each signal is detected from the two locations that are at different distances from the signal. The difference between the two detected signal strength values for each signal is determined, and whichever of the signals has the greatest signal strength difference between the two locations is the signal whose source is relatively closest to the two locations. Since the wavelength of electromagnetic energy at 2.4 GHz is approximately 12.47 centimeters, the two locations would desirably be separated by at least 12.47 centimeters, i.e. the length of one wave.

The exemplary proximity detection apparatus 304 is depicted in FIG. 12 as including a support 308 upon which is situated an RF transceiver 312 having a first antenna 316 and a second antenna 320 at opposite ends of the support 308. The first antenna 316 is situated at a first location 324 on the support 308, i.e., at the first end thereof, and the second antenna 320 is situated at a second location 328 on the support 308, i.e., at a second end thereof. The distance 332 between the first and second antennas 316 and 320 is at least 12.47 centimeters, although other distances may be employed depending upon the needs of the particular application without departing from the present concept. The proximity detection apparatus 304 further includes a processor apparatus 336 that is operatively connected with the RF transceiver 312 to cause it to communicate wirelessly via the BLE protocol the various signal strength values to the server 220. The various routines 224 process the various signal strength values and identify among the various RF transceivers 208 which RF transceiver 208 is situated relatively closest to the proximity detection apparatus 304 based upon the greatest signal strength difference between the two locations 324 and 328. Since the proximity detection apparatus 304 is situated proximate the emulation device 4, the identified RF transceiver 208 is determined to be associated with the relatively closest electronic device 204 and the relatively closest user.

Among the advantages of the present invention are that the device does not require a connection since it is always on, transmitting a unique encrypted rolling ID. Furthermore the point of sale terminal (POS) can detect the unique ID of the device and send it to the “cloud,” i.e., a remote server, for decryption and validation and authentication and return to the POS the real credit card data to be processed.

The system can include “e-paper” which comprises using the camera on a phone to capture an image of a credit card and send it over BLE so that it appears on the credit card's e-paper display. If more than one picture (Credit cards) are sent, a user can select what credit card profile to load. It can also change the magnetic field stripe using a small coil embedded into the credit card.

The system can also store encrypted credit card numbers which will be sent only if a bonded BLE connection is made.

In some embodiments the proximity based payment beacon of the invention is a small beacon which can be adhered to any surface, desk or on actual POS credit card system of a store. It is preferred that this beacon will be adhered very close to the magnetic reader of the POS magnetic card reader system. The beacon sends over Bluetooth a unique ID that it can be encrypted and rolling. When a phone picks up the beacon over Bluetooth, if the RSSI to this beacon is detected on the phone, on the beacon as Reverse RSSI, on both, or the system deems that the proximity between phone and Beacon is very close, say under 2 meters, the phone payment application connects to a server, and sends the Payment Beacon info to server. If server deems that a customer is in line and about to pay for something, the server can pre-authenticate that the owner of that application in that phone can pay. Once the system detects that the shopper is the actual first in line, the cashier can enter the total amount to the POS credit card system. Once the user says, “charge my phone” or the cashier detects that the shopper #1 in line has a phone with BLE payment app, the cashier will press a button or any other method to activate the beacon. The beacon will send a special message to the phone, either in a Bluetooth connected method, or via a special exchange of messages with the phone. The phone payment app, will then connect to a server, and the server will authenticate that the user is indeed first in line. The send either real credit card data, or a virtual credit card number to the phone. The phone will send this numbers over BLE to the Payment beacon. The Payment beacon will then create a magnetic field that would resemble a credit card being swiped and send in a magnetic field the credit card number. The POS magnetic reader will think that a credit card was swiped and will get the credit card numbers. The cashier will then enter the total amount, and the POS will charge the card as a regular credit card.

It can be added as security the following features:

(A) PIN required: When the credit card will be entered, a PIN number or other unique identifier like Billing Zip code, phone number associated with card etc, will be required with the Credit card number. This will authenticate that the owner of the credit card, is indeed making the charge.

(B) Biometric scanner, that can authenticate the user, and send the info to Internet using BLE

(C) A secondary small Display with e-paper, hidden that only the cashier will see the screen, that has built in BLE. This display will connect to the internet via Bluetooth, using a store Bluetooth network, or connecting to the internet using the customer's phone via BLE, or the cashier's phone etc. It will then display a question to ask the customer on the screen. The question could be name and Zip code, where as the answer will be displayed on the screen, and this will not visible to the shopper. If the answer matches, the cashier can press then charge key on the POS.

It thus can be seen that the foregoing demonstrates various devices and methodologies that can facilitate transactions. Other variations will be apparent to one of ordinary skill in the relevant art.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1-27. (canceled)

28. A method of facilitating a transaction, comprising:
receiving from a first radio frequency (RF) transceiver a signal that IS representative of a proximity thereto of a second RF transceiver and a third RF transceiver, one of the first, second, and third RF transceivers being situated at a transaction terminal;
receiving from the second RF transceiver another signal that is representative of a proximity thereto of the first RF transceiver and the third RF transceiver;
identifying, based at least in part on the signal and the another signal, a particular RF transceiver from among the other of the first, second, and third RF transceivers as being situated relatively closer to the transaction terminal;
receiving data that is representative of a preexisting account which IS associated with the particular RF transceiver; and
employing at least a portion of the data to complete a transaction on the transaction terminal.

29. The method of claim 28, further comprising receiving as at least a part of the signal a set of data representative of a strength of a second signal received from the second RF transceiver and a strength of a third signal received from the third RF transceiver.

30. The method of claim 28, further comprising:
sending to the particular RF transceiver an inquiry requesting an authorization of the transaction;
receiving the authorization from the particular RF transceiver and, responsive thereto, initiating the completion of the transaction.

31. The method of claim 28, further comprising:
determining that the relative proximity of each of the other of the first, second, and third RF transceivers to the transaction terminal is at least initially indeterminate;
sending to each of the other of the first, second, and third RF transceivers an inquiry requesting an authorization of the transaction;
receiving the signal and the another signal a period of time subsequent to the sending of the inquiry.

32. The method of claim 28, further comprising:
sending the data to the particular RF transceiver;
receiving on at least one of the transaction terminal and another device in communication with the transaction terminal a transmission from the particular RF transceiver that comprises at least some of the data; and
employing as the at least portion of the data at least a portion of the transmission from the particular RF transceiver.

33. The method of claim 32, further comprising:
receiving the transmission on another device that is in communication with the transaction terminal and that includes a magnetic field generator;
converting on the another device at least a portion of the transmission into a series of analog signals that are representative of the account; and
inputting the series of analog signals into the magnetic field generator to cause the magnetic field generator to generate a time-varying magnetic field that IS detectable by a magnetic card reader of the transaction terminal and that IS representative of the account.

34-38. (canceled)
